(19) United States
(12) Patent Application Publication
(10) Pub. No.: US 2025/0085753 A1
(43) Pub. Date: Mar. 13, 2025

(54) CURRENT BASED POWER MONITORING IN COMPUTING PLATFORMS

(71) Applicant: Intel Corporation, Santa Clara, CA (US)

(72) Inventors: Brandon COURTNEY, Hillsboro, OR (US); Greg LA TOUR, Beaverton, OR (US); Wei-Yi SUNG, New Taipei City (TW)

(21) Appl. No.: 18/367,038

(22) Filed: Sep. 12, 2023

(51) Int. Cl. G06F 1/26

(52) U.S. Cl. CPC G06F 1/26

(57) ABSTRACT

Disclosed are techniques for implementing power monitoring in computing systems using current sense devices.

### TECHNICAL FIELD

Embodiments of the invention relate to the field of computing platforms; and more specifically to monitoring supply power to avoid power out conditions.

### BRIEF DESCRIPTION OF THE DRAWINGS

The invention may best be understood by referring to the following description and accompanying drawings that are used to illustrate embodiments of the invention. In the drawings:

FIG. 1 is a block diagram showing a portion of a conventional computing platform having a fast response over power monitoring scheme.

FIG. 2 is a block diagram showing a portion of a platform with current sense circuitry in accordance with some embodiments.

FIG. 3 is a block diagram of a portion of a small form factor (SFF) compute platform in accordance with some embodiments.

FIG. 4A is a curve showing a relationship between supply voltage and a full scale power measurement level in accordance with some embodiments.

FIG. 4B is a curve showing a relationship between supply voltage and over-power threshold levels in accordance with some embodiments.

FIG. 5 illustrates an example computing system having a current based power out protection scheme in accordance with some embodiments.

FIG. 6 illustrates a block diagram of an example processor and/or SoC for the system of FIG. 5 in accordance with some embodiments.

### DETAILED DESCRIPTION

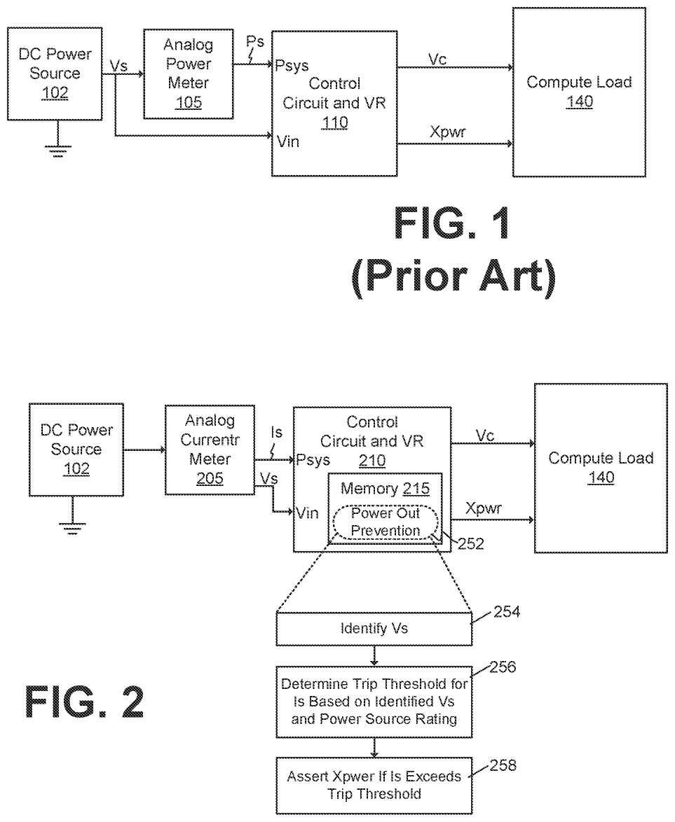

FIG. 1 is a block diagram showing a portion of a conventional computing platform using a fast response power sense mechanism to reduce power and avoid platform brown-out events. The platform has a DC power source 102, an analog power meter IC 105, a Control and VR unit 110, and a compute load (e.g., processor) 140, coupled together as shown.

The DC power source, which may be an AC adapter, a DC regulator, a battery, or a combination of the same, has an associated maximum power delivery capability and will typically shut down when this maximum is drawn for a certain amount of time, e.g., 10 milli-seconds. The power meter 105 monitors total real-time power being drawn from the DC source and provides an analog signal (Ps) corresponding to the real-time power being generated by the DC source. The control circuit, which controls regulated supplies provided to the compute load 120, receives the analog power signal (Ps) at a Psys input (also referred sometimes as a Pmon input) and reduces the power being supplied to the compute load in response to excessive system power being drawn from the DC source 102 in order to prevent a spontaneous DC supply shutdown.

Such a mechanism can be especially important for mobile desktop (MoDT), small form factor, and all-in-one systems where an AC adapter may support the entire platform power load without a battery to supplement transient power spikes. Traditional platforms have used a power meter such as 105 because they can provide the precision and response time required for effective operations. In addition, with many computing platforms, a relatively wide range of acceptable DC supply voltages (e.g., 12V to 20V) may be allowed, so a power meter works well for monitoring power since a designer need not know the actual system voltage value in order to properly use the generated system power signal (Ps). Unfortunately, power meter devices can be expensive, difficult to obtain, and difficult to use for certain desktop platforms. Some systems that use batteries can have battery charge integrated circuits (ICs) with built-in power meters that can generate real-time analog Psys output used by the control circuit, but such charger ICs are typically overly large, complex, and costly, especially for applications that do not require a battery charger device.

In some embodiments, a current meter may be used instead of a power meter. Using control logic, the system can sense the supplied voltage and apply a scaling function to program control circuit registers to correlate the sensed analog current output to system power to support power brown-out prevention functionality implemented by the controller.

FIG. 2 is a block diagram showing a portion of a platform with current sense circuitry in accordance with some embodiments. The platform generally includes a DC power source 102, an analog current meter 205, a control circuit and voltage regulator (VR) module 210, and a compute load 140 coupled as shown. The DC Power source may be any suitable combination of an AC adapter, DC converter, battery, or the like. It can provide a DC output voltage (Vs) that is within a predefined range, e.g., 12V to 24V, and it has an associated guaranteed power level that it can provide for a specified guaranteed amount of time. For example, it might have a nominal output voltage of 15 V with a nominal maximum output power level of 120 W but with a guaranteed ability to provide levels up to a 30% boost (up to 156 W in this example) for a specified amount of time (e.g., 10 mS or less) before shutting down. In this way, the control circuit, through its Psys input, can monitor the power being drawn from DC supply 102 in real-time and be able to react quickly enough to avoid a brown-out condition, e.g., where the power supply 102 shuts off due to an over power, or over current, condition.

The analog current meter 205 may be any suitable circuit for generating an analog signal (Is) that is indicative of the current being drawn from the DC power source 102. In some embodiments, it may provide the supply voltage (Vs), as is shown, to the control and VR unit for generating one or more regulated supplies (Vc), or it could provide the current sense signal (Is) without the main supply (Vs) having to go through it, e.g., if a current loop, external sense resistor, or other sensing scheme is employed. If the latter, the system voltage (Vs) may be provided directly to the controller 210 for input power signal calibration. The current meter may be implemented with any suitable combination of circuit elements including but not limited to commonly available current sense amplifier ICs such as Texas Instruments'™ INA214, OnSemi's™ NCS214R, ST Micro's™ TSC214, or Silergy's™ SY24642 current sense amplifier devices. Such devices are capable of providing fast and accurate analog current sense signals.

The control circuit 210 is configured to determine system power based at least on the system supply voltage (Vs) and the received sensed current signal (Is). It may not actually calculate a power level, but it may be programmed to assert one or more power reducing signals (Xpwr) to the compute load 140 when the sensed current signal exceeds one or more thresholds corresponding to power source limits. The control and VR module 210 generally comprises control logic circuitry and one or more voltage regulators (VRs) used to provide power to a compute load such as a SoC (system on chip) or CPU (central processing unit) processor. Typically, it will include multiple blocks implemented with several different components such as micro controller ICs, VR controllers, bridge circuitry, drivers, inductors, etc. The control logic circuit portion may monitor and control several different platform functions including control of the one or more regulated voltage supplies provided to the compute load 140. In some embodiments, it may include hardened logic circuitry (e.g., finite state machine) and/or memory 215 with available executable instructions to implement a power out prevention routine 252 to monitor system supply power and take platform power reducing measures when necessary to avoid power supply shutdown events.

In some embodiments, the routine initially identifies the nominal power source voltage level at 254. Next, at 256, it determines a trip threshold for Is, the input to Psys, based at least on the identified supply voltage and the power rating for the power source 102. At 258, if the input current (Is) exceeds the trip threshold, the routine causes the Xpwr signal to assert, causing the compute load 140 to reduce its power consumption and thereby reduce the overall platform system power drawn from the power source 102. In some embodiments, the Xpwr signal causes the compute load to throttle consumed compute load power, for example, by causing it to go into and out of higher and lower power states, reduce core operating voltage and frequencies, or execute a core demotion routine, to mention just a few techniques. In addition, it may use more than one power reducing signal to cause different levels of power reduction to occur. Different power thresholds may be used for the different power reducing signals. For example, a higher threshold may be used for a fairly aggressive power reduction for responses to extreme power burst events, while a lower threshold may be used for less extreme power reduction in response to observed higher system power consumption over time but not necessarily exceeding absolute maximum thresholds.

It should be appreciated that the control circuit portion of control circuit and VR 210 may be implemented with any suitable logic circuits or logical circuit blocks used for controlling a voltage regulator supply level and monitoring input supply power to avoid supply power shutdown. In some embodiments, it may be implemented by a power management unit (PMU), power control circuit (PCU), system agent, p-unit, system management unit (SMU), voltage regulator control module, power management integrated circuit (PMIC), micro-controller, or any suitable combination of the same. It may use one or more micro-controllers, state machines, converters, timers, and/or memory such as firmware to perform functions such as monitoring supply power or supply current, setting overpower thresholds, monitoring the durations of higher power events, and issuing power reduction signals when appropriate.

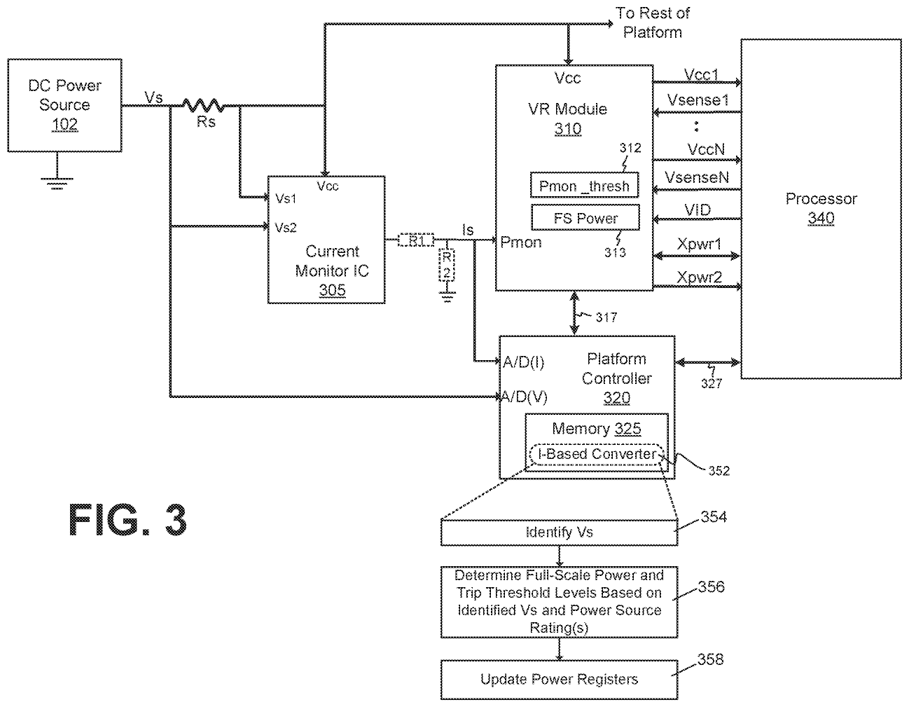

FIG. 3 is a block diagram of a portion of a small form factor (SFF) compute platform in accordance with some embodiments. IN addition to the DC power source 102, the platform includes a current monitor IC 305 with an associated sense resistor Rs, a VR power module 310, a platform controller 320, and a platform processor 340, coupled as shown. The current monitor IC may be implemented with any suitable current sense IC such as those listed above. Along with the VR power module 310 and platform controller 320, the current sense IC has a wide input supply voltage operating range and thus, these ICs may be supplied directly by the power source 102, which may have a value within a relatively wide operating range (e.g., anywhere from 12V to 24V). The sense resistor (Rs) is a high precision, low resistance resistor (e.g., 0.001 Ohms) for measuring the system current, which flows through the resistor. The current sense IC 305 receives voltage values (Vs1, Vs2) from across the sense resistor and generates an output (Is) whose value corresponds to the current measured from the sense resistor and thus to the overall system current. The platform also may include optional divider resistors (R1, R2), depending on the available output range of Is and the available input ranges for the VR power module and platform controller.

The VR power module 310 may be any suitable VR module for providing supplies to the processor 340. It may, and will likely, include more than one chip and/or device. For example, it may have a control portion that is separate from the VR devices that it is controlling. It is common for platform processor designers to define VR module specifications for their processors. For example, some Intel™ processors are designed to be powered by VR modules that comply with a VR module specification such as the IMVP9 or IMVP9.2 specification. Other processors typically have similar acceptable VR specifications. In the depicted example, the VR module 310 has an analog system power input (Pmon) for monitoring system power drawn from the power source 102. It also has at least one register 312 for defining an overpower threshold and a register 313 for storing a full-scale power value that reflects the maximum incoming system current (Is) measurable at the Pmon input. The VR module generates multiple regulated supplies (Vcc1 to VccN) that it provides to processor 340. For example, the supplies may be used to power separate processor domains such as core, graphics, memory, and/or other domains. There is a VID signal used by the processor to request particular voltage levels from one or more of the provided supplies. There are also first and second power reduction lines (Xpwr1, Xpwr2) that may be asserted to cause the processor to take actions to reduce its power consumption. These lines may be dedicated for power reduction in response to excessive power being drawn from the power source, or they may be implemented with existing lines used for other functions. For example, the Xpwr1 line (sometimes also referred to as a VHOT or PROCHOT line) is a two-way line traditionally used for over temperature conditions. The processor may assert (or de-assert) the line when its temperature is excessive, indicating to the VR module that it is reducing its power to reduce its temperature. Similarly, the VR module can assert this line, not only for overpower conditions, but also, when it perceives an over temperature scenario.

The platform controller 320 may be implemented with any suitable logic circuitry such as with a micro-controller or part of another controller within the platform. In some embodiments, the platform controller may be part of an environmental controller, a baseboard controller, a PMIC (power management integrated circuit), the VR module, or the processor itself. The platform controller has A/D inputs for receiving the system current (Is) and voltage (Vs) signals in order to properly execute an I-based converter routine 352, which may be stored in memory 325.

In operation, platform controller 320 executes routine 352 to properly program VR module 310 to monitor power through its power monitor input (Pmon) but while receiving a system current signal (Is) instead of a power signal. To do this, at 354, in early power-on, before many dynamic loads have been enabled, the platform controller samples the input voltage to determine the nominal power source voltage level. At 356, it calculates a full-scale power value and a power threshold, e.g., for registers 312 and 313. It is assumed that even though the power source voltage is unknown, it has a known power output maximum including a maximum surge that can be sustained for a given amount of time.

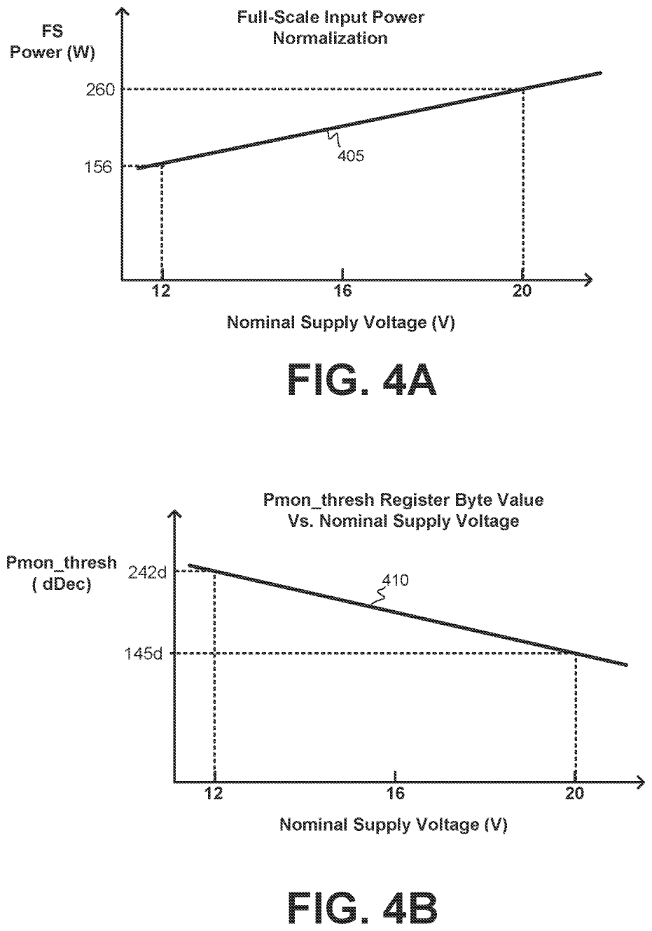

The analog inputs for the VR module and platform controller each have input ranges, e.g., 0V to 1.3 V and thus, the current monitor IC, sense resistor, and voltage divider resistors should be selected so that the system current signal (Is) range is meaningfully perceivable by the Pmon and A/D(I) inputs. For example, assume that these inputs have a range of 0 to 1.3 V. With a fixed maximum expected power (e.g., 156 W), the highest current will be seen when the system voltage is at its lowest acceptable level. Assume as an example that the voltage can range from 12V to 20V. Then the max current would be 156 W/12V, which is 13 Amps. The sense resistor, A/D amplification factors, and resistor divider ratios should be selected such that this 13 Amp system current generates a 1.3V level at the Pmon input when power is at 156 W. In this case, the FS power level would be 156 W. As the supply voltage goes up, the max power level programmed into the max power register also rises. This is represented by curve 405 in FIG. 4A. Essentially, this is telling the VR module the power level based at least on the Pmon input when/if Pmon is at its maximum value (e.g., 1.3 V). As another example, when the system supply voltage is 20 V, the full-scale current of 13 A would correspond to a max power level of 260 W (13 A*20 V). This value would be programmed into the FS power register. This register allows the VR module to convert the input Pmon current signal into a power value.

The trip threshold level may be selected as desired for a given implementation. For example, a 5% margin from max. burst power may be desired. With a max. surge power of 156 W, this would correspond to a power level of about 148 W (0.95*156). If the register is an 8-bit register, with full scale 156 W corresponding to a digital register value of 255d (or FFh), then the 148 W trip level would be stored in the register as 242d (or F2h). The actual power trip level will likely stay the same in most implementations (148 W in this example), but the trip level programmed into the threshold register will vary depending on the monitored supply voltage level. Since current will be lower for higher supply voltages with the same power, the trip threshold levels will go down as supply voltage increases. This is illustrated in curve 410 of FIG. 4B. For example, with a 20 V supply voltage, the 148 W trip level corresponds to a system current (Is) of 7.4 A, which would generate a Pmon input voltage of 0.74 V. Thus, the power threshold register for a 148 W trip point would be set to 145d (or 91h).

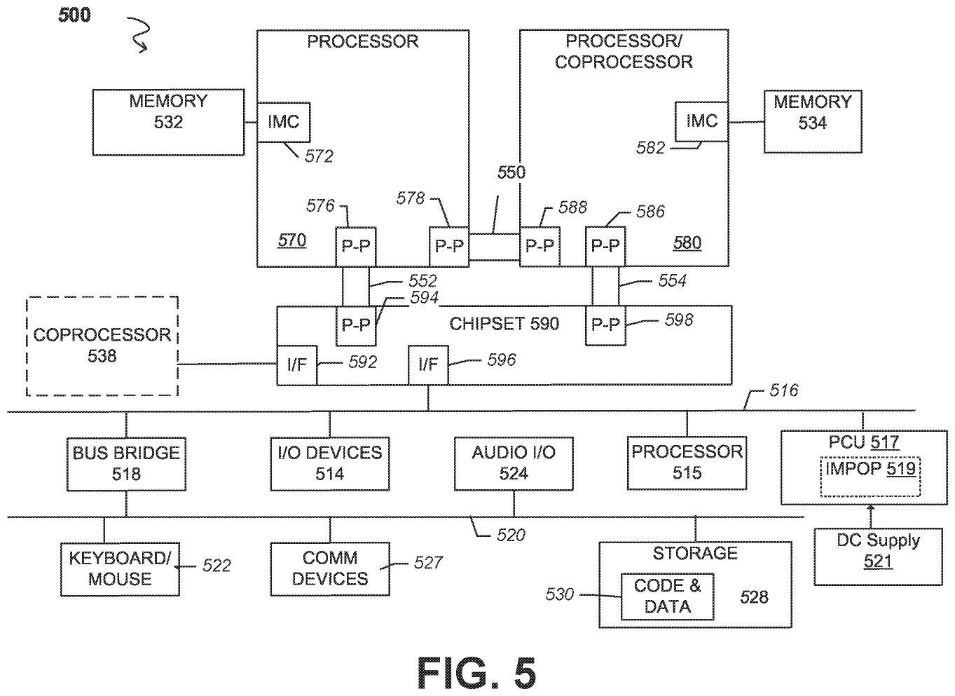

FIG. 5 illustrates an example computing system. Multiprocessor system 500 is an interfaced system and includes a plurality of processors including a first processor 570 and a second processor 580 coupled via an interface 550 such as a point-to-point (P-P) interconnect, a fabric, and/or bus. In some examples, the first processor 570 and the second processor 580 are homogeneous. In some examples, first processor 570 and the second processor 580 are heterogenous. Though the example system 500 is shown to have two processors, the system may have three or more processors, or maybe a single processor system. In some examples, the computing system is implemented, wholly or partially, with a system on a chip (SoC) or a multi-chip (or multi-chiplet) module, in the same or in different package combinations.

Processors 570 and 580 are shown including integrated memory controller (IMC) circuitry 572 and 582, respectively. Processor 570 also includes interface circuits 576 and 578, along with core sets. Similarly, second processor 580 includes interface circuits 586 and 588, along with a core set as well. A core set generally refers to one or more compute cores that may or may not be grouped into different clusters, hierarchal groups, or groups of common core types. Cores may be configured differently for performing different functions and/or instructions at different performance and/or power levels. The processors may also include other blocks such as memory and other processing unit engines.

Processors 570, 580 may exchange information via the interface 550 using interface circuits 578, 588. IMCs 572 and 582 couple the processors 570, 580 to respective memories, namely a memory 532 and a memory 534, which may be portions of main memory locally attached to the respective processors.

Processors 570, 580 may each exchange information with a network interface (NW I/F) 590 via individual interfaces 552, 554 using interface circuits 576, 594, 586, 598. The network interface 590 (e.g., one or more of an interconnect, bus, and/or fabric, and in some examples is a chipset) may optionally exchange information with a coprocessor 538 via an interface circuit 592. In some examples, the coprocessor 538 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 570, 580 or outside of both processors, yet connected with the processors via an interface such as P-P interconnect, such that either or both processors' local cache information may be stored in the shared cache if a processor is placed into a low power mode.

Network interface 590 may be coupled to a first interface 516 via interface circuit 596. In some examples, first interface 516 may be an interface such as a Peripheral Component Interconnect (PCI) interconnect, a PCI Express interconnect, or another I/O interconnect. In some examples, first interface 516 is coupled to a power control circuit (PCU) 517, which may include circuitry, software, and/or firmware to perform power management operations with regard to the processors 570, 580 and/or co-processor 538. PCU 517 provides control information to one or more voltage regulators (not shown) to cause the voltage regulator(s) to generate the appropriate regulated voltage(s). PCU 517 also provides control information to control the operating voltage generated. In various examples, PCU 517 may include a variety of power management logic units (circuitry including hardened logic circuitry and/or instruction execution circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software). In this embodiment, the PCU 517 also includes a current mode power off protection (IMPOP) circuit 519, which may be implemented in accordance with techniques described herein to monitor system current in order to prevent a DC power source from shutting down.

PCU 517 is illustrated as being present as logic circuitry separate from the processor 570 and/or processor 580. In other cases, PCU 517 may execute on a given one or more of cores (not shown) of processor 570 or 580. In some cases, PCU 517 may be implemented as a microcontroller (dedicated or general-purpose) or other control logic c circuitry configured to execute its own dedicated power management code, sometimes referred to as P-code. In yet other examples, power management operations to be performed by PCU 517 may be implemented externally to a processor, such as by way of a separate power management integrated circuit (PMIC) or another component external to the processor. In yet other examples, power management operations to be performed by PCU 517 may be implemented within BIOS or other system software. Along these lines, power management may be performed in concert with other power control circuits implemented autonomously or semi-autonomously, e.g., as controllers or executing software in cores, clusters, IP blocks and/or in other parts of the overall system. Similarly, IMPOP circuit 519 while shown as being within PCU 517 may be implemented within or apart from PCU 517, e.g., using one or more separate logic circuit blocks or ICs.

Various I/O devices 514 may be coupled to first interface 516, along with a bus bridge 518 which couples first interface 516 to a second interface 520. In some examples, one or more additional processor(s) 515, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 516. In some examples, second interface 520 may be a low pin count (LPC) interface. Various devices may be coupled to second interface 520 including, for example, a keyboard and/or mouse 522, communication devices 527 and storage circuitry 528. Storage circuitry 528 may be one or more non-transitory machine-readable storage media as described below, such as a disk drive or other mass storage device which may include instructions/code and data 530 and may implement the storage in some examples. Further, an audio I/O 524 may be coupled to second interface 520. Note that other architectures than the point-to-point architecture described above are possible. For example, instead of the point-to-point architecture, a system such as multiprocessor system 500 may implement a multi-drop interface or other such architecture.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

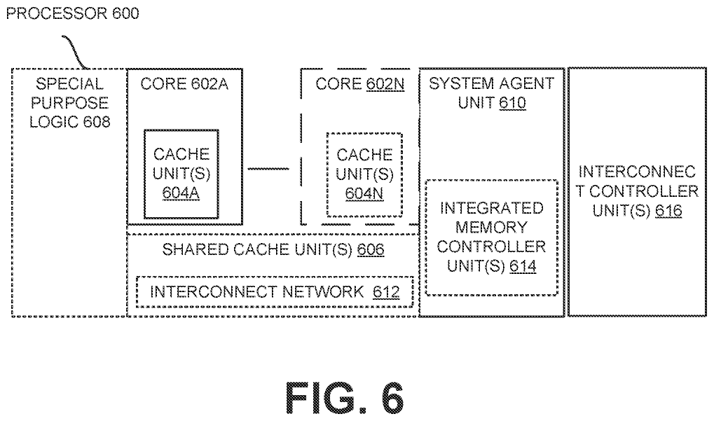

FIG. 6 illustrates a block diagram of an example processor and/or SoC 600 that may have one or more cores and an integrated memory controller. The solid lined boxes illustrate a processor 600 with a single core 602(A), system agent unit circuitry 610, and a set of one or more interface controller unit(s) circuitry 616, while the optional addition of the dashed lined boxes illustrates an alternative processor 600 with multiple cores 602(A)-(N), a set of one or more integrated memory controller unit(s) circuitry 614 in the system agent unit circuitry 610, and special purpose logic 608, as well as a set of one or more interface controller units circuitry 616. Note that the processor 600 may be one of the processors 570 or 580, or co-processor 538 or 515 of FIG. 5 and any of these processors may be one of the compute loads or processors of FIG. 2 or 3.

Thus, different implementations of the processor 600 may include: 1) a CPU with the special purpose logic 608 being integrated graphics and/or scientific (throughput) logic (which may include one or more cores, not shown), and the cores 602(A)-(N) being one or more general purpose cores (e.g., general purpose in-order cores, general purpose out-of-order cores, or a combination of the two); 2) a coprocessor with the cores 602(A)-(N) being a large number of special purpose cores intended primarily for graphics and/or scientific (throughput); and 3) a coprocessor with the cores 602(A)-(N) being a large number of general purpose in-order cores. Thus, the processor 600 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 600 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 604(A)-(N) within the cores 602(A)-(N), a set of one or more shared cache unit(s) circuitry 606, and external memory (not shown) coupled to the set of integrated memory controller unit(s) circuitry 614. The set of one or more shared cache unit(s) circuitry 606 may include one or more mid-level caches, such as level 2 (L2), level 3 (L3), level 4 (L4), or other levels of cache, such as a last level cache (LLC), and/or combinations thereof. While in some examples interface network circuitry 612 (e.g., a ring interconnect) interfaces the special purpose logic 608 (e.g., integrated graphics logic), the set of shared cache unit(s) circuitry 606, and the system agent unit circuitry 610, alternative examples use any number of well-known techniques for interfacing such units. In some examples, coherency is maintained between one or more of the shared cache unit(s) circuitry 606 and cores 602(A)-(N). In some examples, interface controller units circuitry 616 couple the cores 602 to one or more other devices 618 such as one or more I/O devices, storage, one or more communication devices (e.g., wireless networking, wired networking, etc.), etc.

In some examples, one or more of the cores 602(A)-(N) are capable of multi-threading. The system agent unit circuitry 610 includes those components coordinating and operating cores 602(A)-(N). The system agent unit circuitry 610 may include, for example, power control circuit (PCU) circuitry and/or display unit circuitry (not shown). The PCU may be or may include logic and components needed for regulating the power state of the cores 602(A)-(N) and/or the special purpose logic 608 (e.g., integrated graphics logic). The display unit circuitry is for driving one or more externally connected displays.

The cores 602(A)-(N) may be homogenous in terms of instruction set architecture (ISA). Alternatively, the cores 602(A)-(N) may be heterogeneous in terms of ISA; that is, a subset of the cores 602(A)-(N) may be capable of executing an ISA, while other cores may be capable of executing only a subset of that ISA or another ISA.

Illustrative examples of the technologies disclosed herein are provided below. An embodiment of the technologies may include any one or more, and any compatible combination of, the examples described below.

Example 1 is an apparatus that includes control circuitry. The control circuitry has a power input to monitor power from a DC power source that is to provide power to a computing load. The control circuitry also includes a system voltage input to identify a voltage of the DC power source and logic circuitry to reduce power to the computing load in response to the monitored power reaching or exceeding a power threshold, and the control circuitry is to program the power threshold based at least on the identified DC power source voltage.

Example 2 includes the subject matter of example 1, and wherein the control circuitry has a power reducing signal line to cause the computing load to throttle down its power consumption when asserted by the logic circuitry to reduce power to the computing load.

Example 3 includes the subject matter of any of examples 1-2, and wherein the control circuitry is implemented with a voltage regulator (VR) controller.

Example 4 includes the subject matter of any of examples 1-3, and wherein the control circuitry is implemented with the VR controller and a platform controller.

Example 5 includes the subject matter of any of examples 1-4, and wherein the power input is to be coupled to a current meter to receive a signal indicative of current from the DC power source.

Example 6 includes the subject matter of any of examples 1-5, and wherein the current meter is implemented with a current sense amplifier and a sense resistor.

Example 7 includes the subject matter of any of examples 1-6, and wherein the logic correlates the received current indicative signal to a power level based at least on the identified power source voltage level.

Example 8 includes the subject matter of any of examples 1-7, and wherein the DC power source does not include a battery.

Example 9 is a computing platform. It includes a voltage regulator (VR) module and a processor. The VR module has a VR powered from a DC power source. The processor is to receive power from the VR, and the VR module has a power monitor input to receive an analog signal indicative of current being supplied by the DC power source. There is also logic circuitry to translate the current indicative analog signal into at least one power parameter to reduce power to the processor in response to a power threshold being reached or exceeded by the DC power source.

Example 10 includes the subject matter of example 9, and wherein the VR module includes VR control circuitry with at least one register to be programmed with a translated power threshold value.

Example 11 includes the subject matter of any of examples 9-10, and further comprising a platform controller to identify a supply voltage from the DC power source and to implement the logic to translate the current indicative signal based at least on the identified voltage.

Example 12 includes the subject matter of any of examples 9-11, and wherein the platform controller is to program one or more power parameter registers of the VR module based at least on the identified supply voltage, the one or more register power parameters to be correlated with the current indicative signal received by the VR module.

Example 13 includes the subject matter of any of examples 9-12, and further comprising a current meter to generate the current indicative analog signal.

Example 14 includes the subject matter of any of examples 9-13, and wherein the current meter is implemented with a current sense amplifier integrated circuit.

Example 15 includes the subject matter of any of examples 9-14, and wherein the DC power source does not include a battery.

Example 16 includes the subject matter of any of examples 9-15, and wherein the VR module has a power reducing line coupled to the processor to cause the processor to throttle down its power in response to the power reducing line being asserted by the VR module in response to the power threshold being reached or exceeded.

Example 17 is a small form factor (SFF) computer system that includes a processor, a voltage regulator (VR), a VR control circuit, and a platform control circuit. The voltage regulator is to receive power from a DC power source and to provide a regulated voltage supply to the processor. The VR control circuit is to control the VR and to issue a power reducing signal to the processor in response to an over-power condition occurring. The VR control circuit has a power monitor input to receive an analog signal indicative of current being drawn from the DC power source. The platform control circuit has an analog input to identify a voltage of the DC power source and is to program the VR control circuit with one or more power parameters based at least on the identified DC power source voltage.

Example 18 includes the subject matter of example 17, and wherein at least one of the one or more power parameters is a threshold that when exceeded indicates an occurrence of the over-power condition.

Example 19 includes the subject matter of any of examples 17-18, and wherein the DC power source includes an AC adapter.

Example 20 includes the subject matter of any of examples 17-19, and wherein the DC power source has no battery.

Example 21 includes the subject matter of any of examples 17-20, and wherein the power reducing signal is a PROCHOT or VHOT signal.

Example 22 includes the subject matter of any of examples 17-21, and further comprises a current meter coupled between the DC power source and VR to generate the current indicative analog signal.

Example 23 includes the subject matter of any of examples 17-22, and wherein the current meter is implemented with a current sense amplifier and a sense resistor.

Example 24 includes the subject matter of any of examples 17-23, and wherein the one or more power parameters include multiple power threshold levels corresponding to different levels of power reducing responses.

Example 25 includes the subject matter of any of examples 17-24, and wherein the processor comprises an integrated circuit with a CPU core complex and an integrated graphics processing unit.

Example 26 includes the subject matter of any of examples 17-25, and wherein the one or more power parameters include a scaling factor to be used by the VR control circuit to interpret the current indicative analog signal into a power parameter.

Example 27 includes the subject matter of any of examples 17-26, and wherein the platform control circuit is part of the VR control circuit.

Example 28 is a computer readable storage medium having instructions that when executed cause a control circuit to perform a method. The method includes identifying a DC power source supply voltage, calculating at least one power parameter based at least on the identified supply voltage, and programming a power monitoring control circuit with the at least one power parameter. The power monitoring control circuit is to cause a processor to reduce its consuming power in response to the power monitoring control circuit detecting, based at least on the at least one power parameter, that an overpower condition is occurring.

Example 29 includes the subject matter of example 28, and wherein the power monitoring control circuit is part of a voltage regulator (VR) controller.

Example 30 includes the subject matter of any of examples 28-29, and wherein the at least one power parameter is a scaling factor.

Example 31 includes the subject matter of any of examples 28-30, and wherein the at least one power parameter is a power threshold correlated with the identified supply voltage.

Example 32 includes the subject matter of any of examples 28-31, and wherein the control circuit is part of a platform controller that is coupled to a VR controller that includes the power monitoring control circuit.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function. It should be appreciated that different circuits or modules may consist of separate components, they may include both distinct and shared components, or they may consist of the same components. For example, A controller circuit may be a first circuit for performing a first function, and at the same time, it may be a second controller circuit for performing a second function, related or not related to the first function.

The meaning of “in” includes “in” and “on” unless expressly distinguished for a specific description.

The terms “substantially,” “close,” “approximately,” “near,” and “about,” unless otherwise indicated, generally refer to being within +/−10% of a target value.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

It is pointed out that those elements of the figures having the same reference numbers (or names) as the elements of any other figure can operate or function in any manner similar to that described but are not limited to such.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are dependent upon the platform within which the present disclosure is to be implemented.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. Memory elements, as described herein, are examples of a computer readable storage medium. A non-exhaustive list of more specific examples of a computer readable storage medium may include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context. As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “processor” means at least one hardware circuit configured to carry out instructions contained in program code. The hardware circuit may be implemented with one or more integrated circuits. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a graphics processing unit (GPU), a controller, and so forth.

The flowchart and block diagrams in the figures illustrate the architecture, functionality, and operation of possible implementations of systems, methods, and computer program products according to some embodiments. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. An apparatus, comprising:
control circuitry having a power input to monitor power from a DC power source that is to provide power to a computing load;
the control circuitry including a system voltage input to identify a voltage of the DC power source and logic circuitry to reduce power to the computing load in response to the monitored power reaching or exceeding a power threshold, wherein the control circuitry is to program the power threshold based at least on the identified DC power source voltage.

2. The apparatus of claim 1, wherein the control circuitry has a power reducing signal line to cause the computing load to throttle down its power consumption in response to a logic circuitry assertion to reduce power to the computing load.

3. The apparatus of claim 1, wherein the control circuitry is implemented with a voltage regulator (VR) controller.

4. The apparatus of claim 3, wherein the control circuitry is implemented with the VR controller and a platform controller.

5. The apparatus of claim 1, wherein the power input is to be coupled to a current meter to receive a signal indicative of current from the DC power source.

6. The apparatus of claim 5, wherein the current meter is implemented with a current sense amplifier and a sense resistor.

7. The apparatus of claim 5, wherein the logic circuit is to correlate the received current indicative signal to a power level based at least on the identified power source voltage level.

8. The apparatus of claim 1, wherein the DC power source does not include a battery.

9. A computing platform, comprising:
a voltage regulator (VR) module having a VR to be powered from a DC power source; and
a processor to receive power from the VR, the VR module having a power monitor input to receive an analog signal indicative of current being supplied by the DC power source and logic circuitry to translate the current indicative analog signal into at least one power parameter to reduce power to the processor in response to a power threshold being reached or exceeded by the DC power source.

10. The computing platform of claim 9, wherein the VR module includes VR control circuitry with at least one register to be programmed with a translated power threshold value.

11. The computing platform of claim 9, further comprising a platform controller to identify a supply voltage from the DC power source and to implement the logic circuitry to translate the current indicative signal based at least on the identified voltage.

12. The computing platform of claim 11, wherein the platform controller is to program one or more power parameter registers of the VR module based at least on the identified supply voltage, the one or more register power parameters to be correlated with the current indicative signal received by the VR module.

13. The computing platform of claim 9, further comprising a current meter to generate the current indicative analog signal.

14. The computing platform of claim 13, wherein the current meter is implemented with a current sense amplifier integrated circuit.

15. The computing platform of claim 9, wherein the DC power source does not include a battery.

16. The computing platform of claim 9, wherein the VR module has a power reducing line coupled to the processor to cause the processor to throttle down its power responsive to the power reducing line being asserted by the VR module in response to the power threshold being reached or exceeded.

17. A computer system, comprising:
a processor;
a voltage regulator to receive power from a DC power source and to provide a regulated voltage supply to the processor;
a VR control circuit to control the VR and to issue a power reducing signal to the processor in response to an over-power condition occurring; the VR control circuit having a power monitor input to receive an analog signal indicative of current being drawn from the DC power source; and
a platform control circuit having an analog input to identify a voltage of the DC power source, the platform control circuit to program the VR control circuit with one or more power parameters based at least on the identified DC power source voltage, wherein the computer system is a small form factor (SFF) computer system.

18. The system of claim 17, wherein at least one of the one or more power parameters is a threshold that in response to being exceeded indicates an occurrence of the over-power condition.

19. The system of claim 17, wherein the DC power source includes an AC adapter.

20. The system of claim 19, wherein the DC power source has no battery.
